(19) United States
(12) Patent Application Publication
(10) Pub. No.: US 2004/0221509 A1
(43) Pub. Date: Nov. 11, 2004

(54) Door module

(76) Inventors: Kazuma Shibata, Hamamatsu-shi (JP); Kazuaki Tsujita, Toyohashi-shi (JP)

Correspondence Address: SHERIDAN ROSS PC, 1560 BROADWAY, SUITE 1200, DENVER, CO, 80202

(21) Appl. No.: 10/821,808

(22) Filed: Apr. 9, 2004

(30) Foreign Application Priority Data
Apr. 11, 2003 (JP) 2003-108085

(51) Int. Cl. E05F 11/44

(52) U.S. Cl. 49/350

(57) ABSTRACT

The present invention relates to a door module capable of raising and lowering a window glass with few components in number. The door module has a window motor, a power transmission arm, a guide rail, and a carrier. The power transmission arm is operably coupled to the window motor. The carrier is supported by the guide rail so as to be movable along the longitudinal direction of the guide rail. The carrier has a receiving rail engaged with an engaging projection of the power transmission arm so that the carrier is moved along the longitudinal direction of the guide rail in accordance with the rotation of the power transmission arm. The carrier also has protrusions engaged with the guide rail so as to restrain the carrier from moving relative to the guide rail along a direction that intersects the longitudinal direction of the guide rail.

### BACKGROUND OF THE INVENTION

The present invention relates to a door module for moving a window glass, and more particularly to a single arm type door module for raising and lowering a window glass.

As a window regulator device for raising and lowering a window glass for a vehicle door, there are known such a X-arm type as disclosed in Japanese Laid-Open Patent Publication No. 2003-49583 and such a single arm type as disclosed in Japanese Laid-Open Patent Publication Nos. 6-146708 and 2000-27531. The single arm type window regulator device has advantages of being less number of components and lighter-weight than the X-arm type window regulator device. For this reason, the single arm type window regulator devices have widely been used recently.

In the window regulator device disclosed in the Japanese Laid-Open Patent Publication No. 6-146708, the window glass has been supported by a guide member, and is raised and lowered following up-and-down movements of the guide member. The guide member moves up and down via a lift arm to be rotated by a driving mechanism. When the window glass rises and falls, each of rollers provided on both sides of the window glass moves along one of two guide rails provided on the vehicle door.

The window regulator device disclosed in the Japanese Laid-Open Patent Publication No. 2000-27531 is equipped with: a window motor; a drive arm to be rotated by the window motor; a lift arm for rising and falling in synchronization with the drive arm; a supporting member for rising and falling in synchronization with the lift arm; a control rail for guiding the lift arm; and a guide rail for guiding the supporting member. The window glass is supported by the supporting member, and rises and falls in synchronization with the supporting member.

It is important for stable rise and fall of the window glass that components relating to rise and fall of the window glass have been accurately assembled. The window regulator device of the Japanese Laid-Open Patent Publication Nos. 6-146708 and 2000-27531 is constructed of a multitude of components. For this reason, it is a very troublesome operation to accurately assemble these components.

### SUMMARY OF THE INVENTION

Accordingly, it is an object of the present invention to provide a door module capable of raising and lowering a window glass with few components in number.

To achieve the foregoing and other objectives, and in accordance with the purpose of the present invention, a door module for moving a window glass is provided. The door module has a window motor, a power transmission arm, a guide member, and a carrier. The power transmission arm is operably coupled to the window motor. The power transmission arm is rotated about a predetermined rotation axis by the window motor. The power transmission arm has a power transmission portion located apart from the rotation axis. The guide member extends along a moving direction of the window glass. The moving direction of the window glass is a direction along which the window glass moves. The carrier is supported by the guide member so as to be movable along the moving direction of the window glass. The window glass is installed onto the carrier. The carrier, together with the window glass, is moved on the guide member along the moving direction of the window glass. The carrier has a first engaging portion engaged with the power transmission portion so that the carrier is moved along the moving direction of the window glass in accordance with the rotation of the power transmission arm. The carrier also has a second engaging portion engaged with the guide member so as to restrain the carrier from moving relative to the guide member along a direction that intersects the moving direction of the window glass.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a door module installed to a front door of an automobile when viewed from the outside of the automobile;

FIG. 2(a) is an enlarged front view showing the door module of FIG. 1;

FIG. 2(b) is a sectional view taken on line A-A of FIG. 2(a);

FIG. 3 is a sectional view taken on line B-B of FIG. 2(a);

FIG. 4 is an enlarged front view showing one portion of FIG. 2(a);

FIG. 5 is a sectional view taken on line C-C of FIG. 4;

FIG. 6(a) is a side view showing a carrier in the door module of FIG. 1;

FIG. 6(b) is a rear view showing the carrier;

FIG. 7 is a side view showing a connected portion between the carrier and a power transmission arm; and

FIG. 8 is an enlarged side view showing one portion of FIG. 7.

### DETAILED DESCRIPTION OF THE PREFERRED EMBODIMENTS

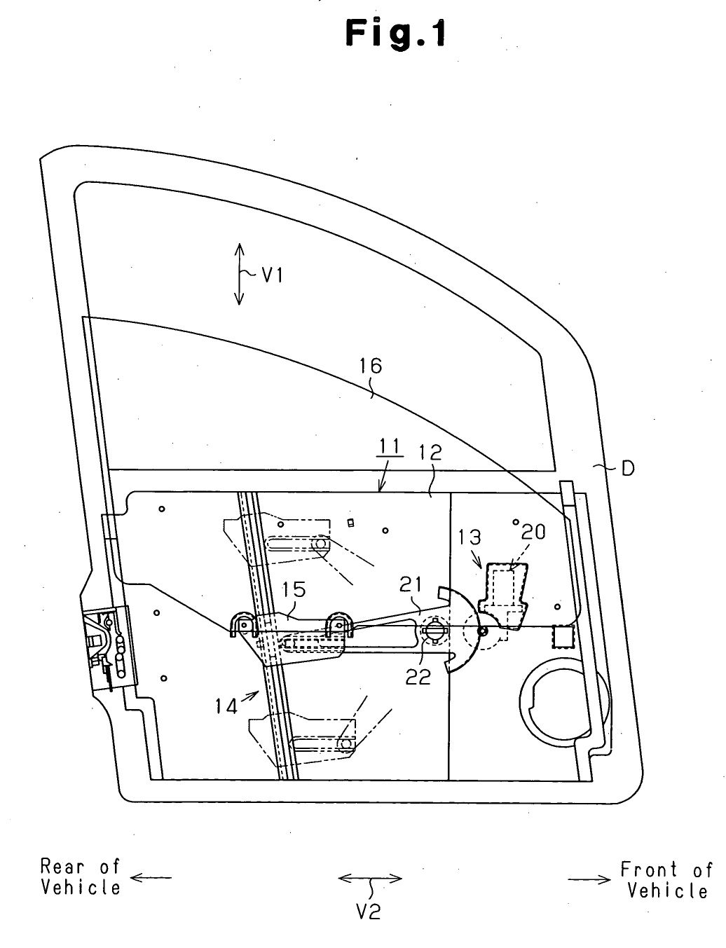

Hereinafter, with reference to FIGS. 1 to 8, the description will be made of an embodiment of the present invention.

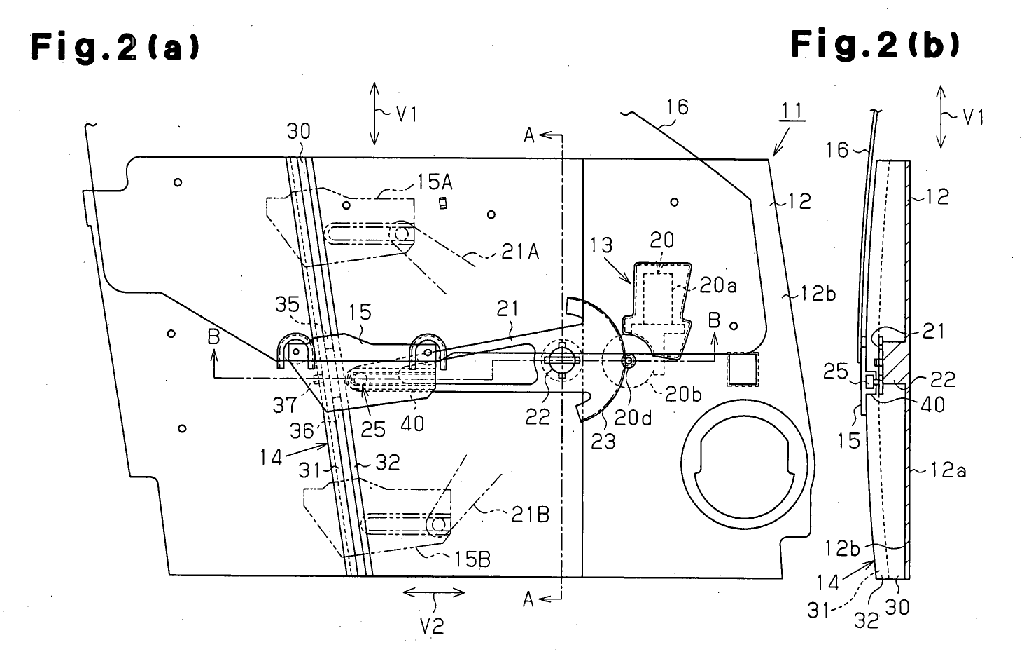

As shown in FIG. 1, a door module 11 according to the present embodiment has been installed to a front door D of an automobile to raise and lower a window glass 16 of the front door D. The window glass 16 has a predetermined curvature as shown in FIG. 2(b).

As shown in FIG. 2(a), the door module 11 is equipped with: a module panel 12; a window regulator 13; a guide rail 14 as a guide member; and a carrier 15.

The module panel 12 is provided more inwardly of a vehicle than an outer panel (not shown) of the front door D, in more details, between the outer panel and a door trim (not shown). The module panel 12 is made of synthetic resin, and is shaped like a substantially parallelogrammic plate as shown in FIG. 2(a). As shown in FIG. 2(b), a surface of the module panel 12 for facing a passenger compartment is a panel inner surface 12a while a surface of the module panel 12 for facing away from the passenger compartment is a panel outer surface 12b.

The window regulator 13 is equipped with a window motor 20 and a power transmission arm 21, which is operably coupled to the window motor 20. The window motor 20 is provided on the panel inner surface 12a.

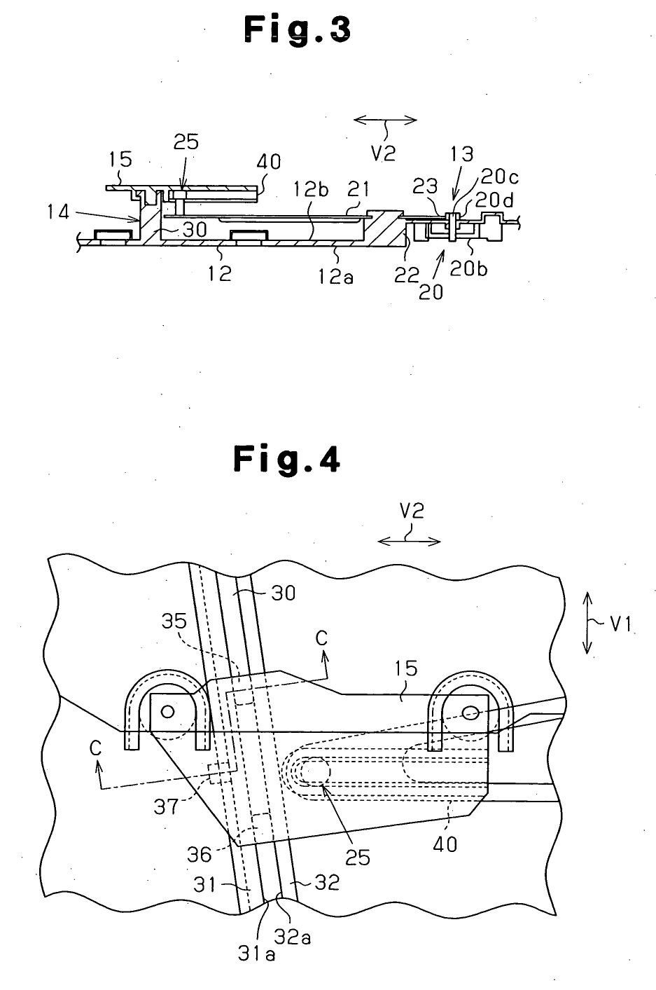

As shown in FIG. 2(a), the window motor 20 is comprised of a motor portion 20a and a gear portion 20b, and the motor portion 20a and the gear portion 20b are made integral with each other. As shown in FIG. 3, the gear portion 20b has an output shaft 20c for penetrating the module panel 12 to project from the panel outer surface 12b. At a tip of the output shaft 20c for projecting from the panel outer surface 12b, there is installed a pinion gear 20d which rotates integrally with the output shaft 20c.

As shown in FIG. 2(a), the power transmission arm 21 is installed on an arm supporting portion 22 provided on the panel outer surface 12b. The power transmission arm 21 is capable of rotating with the arm supporting portion 22 as a fulcrum within a plane parallel with the panel outer surface 12b. In other words, the power transmission arm 21 is capable of rotating about a predetermined rotation axis. The window motor 20 is located more forwardly of the vehicle (in FIG. 2(a), on the right side) than the arm supporting portion 22.

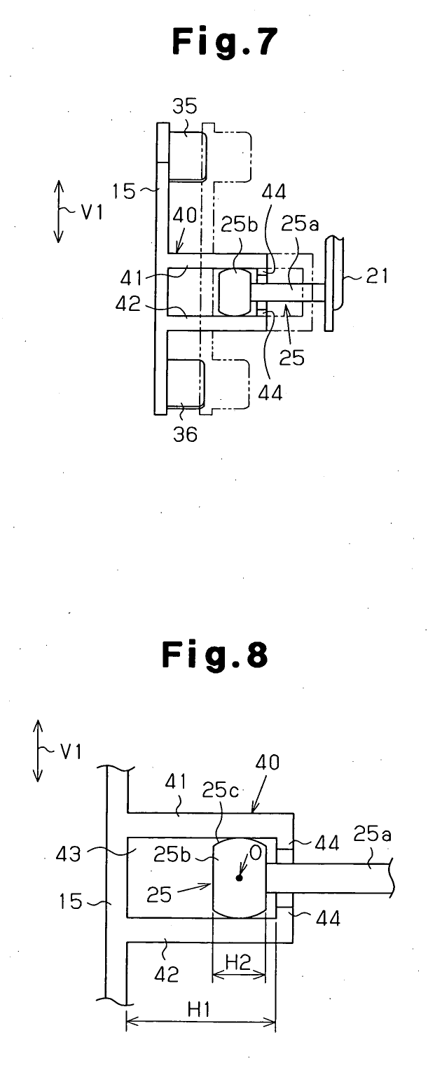

At one end portion of the power transmission arm 21, there is provided a sector gear portion 23, and the sector gear portion 23 is engaged by the pinion gear 20d. For the reason, when the pinion gear 20d rotates, the power transmission arm 21 reciprocally rotates within a fixed angle. At another end portion of the power transmission arm 21, which is located on the opposite side to the one end portion provided with the sector gear portion 23, there is provided an engaging projection 25 as a power transmission portion. In other words, the power transmission arm has the engaging projection 25 located apart from the rotation axis. The engaging projection 25 is provided on a surface of the power transmission arm 21, facing away from the passenger compartment (in FIG. 3, an upper surface). As shown in FIG. 7, the engaging projection 25 is comprised of a proximal end portion 25a and a tip portion 25b provided at a tip of the proximal end portion 25a, having a larger diameter than the proximal end portion 25a.

As shown in FIGS. 2(a) and 2(b), the guide rail 14 is provided on the panel outer surface 12b. The guide rail 14 is made of synthetic resin, and has been integrally formed with the module panel 12. The guide rail 14 is located more rearward of the vehicle (in FIG. 2(a), to the left) than the arm supporting portion 22. The guide rail 14 extends in a straight line substantially along the up-and-down direction indicated by an arrow V1 in FIGS. 2(a) and 2(b). The longitudinal direction of the guide rail 14 corresponds to a moving direction of the window glass 16. In other words, the guide rail 14 extends along the moving direction of the window glass 16. The moving direction of the window glass 16 is a direction along which the window glass 16 moves. A surface of the guide rail 14 facing away from the passenger compartment is a crook surface having the same curvature as the window glass 16.

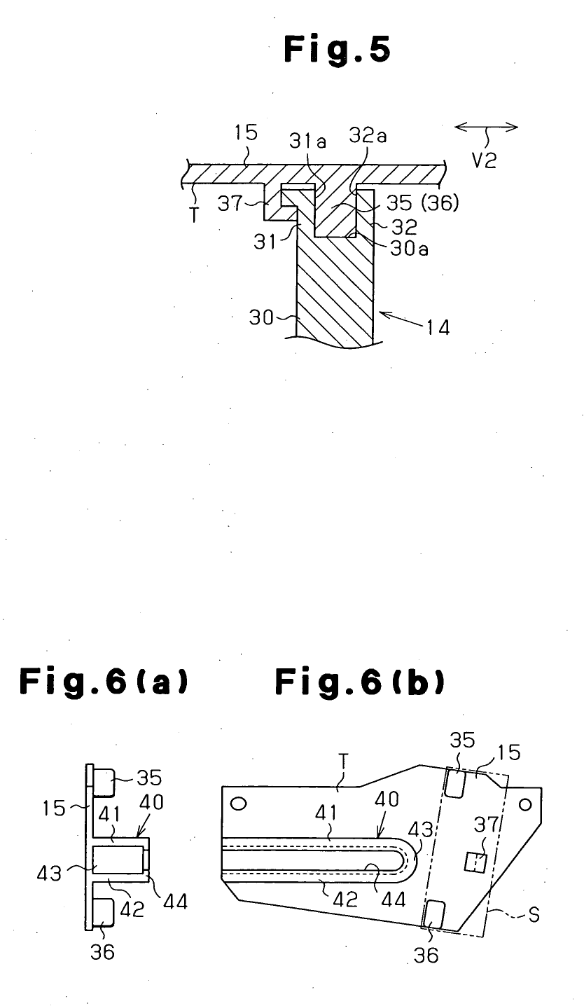

As shown in FIGS. 4 and 5, the guide rail 14 is comprised of a base portion 30 for projecting from the module panel 12 (See FIG. 3), a first guide portion 31 and a second guide portion 32 which have been provided on the base portion 30. Both guide portions 31 and 32 have been integrally formed with the base portion 30.

As shown in FIGS. 2(A) and 2(B), the base portion 30 extends along the longitudinal direction of the guide rail 14 over the entire guide rail 14. The base portion 30 has a fixed width as shown in FIG. 2(a), and has height that gradually increases toward the center in the up-and-down direction from both ends in the up-and-down direction as shown in FIG. 2(b). A surface of the base portion 30 facing away from the passenger compartment is a crook surface having the same curvature as the window glass 16.

As shown in FIGS. 4 and 5, the first guide portion 31 is provided more rearward of the vehicle than the second guide portion 32, and has an inverted L-character-shaped sectional shape. The second guide portion 32 has a rectangular sectional shape. Both guide portions 31 and 32 extend along the longitudinal direction of the guide rail 14 over the entire guide rail 14, and have a fixed width and height. Each of surfaces located in both guide portions 31 and 32 facing away from the passenger compartment is a crook surface having the same curvature as the window glass 16.

As long as each of surfaces located in both guide portions 31 and 32 facing away from the passenger compartment is a crook surface having the same curvature as the window glass 16, the base portion 30 and the guide portions 31 and 32 according to the present embodiment may have any heights. The base portion 30 and the guide portions 31 and 32 according to the present embodiment may be modified, for example, in such a manner that the base portion 30 has a fixed height, and the guide portions 31 and 32 have height that gradually increases toward the center in the up-and-down direction from both ends in the up-and-down direction.

Each of the first guide portion 31 and the second guide portion 32 has one of two surfaces which oppose to each other. The surfaces are arranged along the widthwise direction of the guide rail 14. As shown in FIG. 5, one of the above-described two surfaces in the first guide portion 31 is a first guide surface 31a, and one of the above-described two surfaces in the second guide portion 32 is a second guide surface 32a. The guide surfaces 31a and 32a are parallel to each other, and are parallel to the longitudinal direction of the guide rail 14. In this respect, the guide surfaces 31a, 32a may not always be parallel to each other. A surface of the base portion 30 facing away from the passenger compartment is a guide underside 30a. In other words, the guide rail 14 has a guide groove to be defined by the first guide surface 31a, the second guide surface 32a, and the guide underside 30a.

As shown in FIG. 2(a), the carrier 15 is supported by the guide rail 14, and is capable of sliding on the guide rail 14 along the longitudinal direction thereof. Onto the carrier 15, there is installed the window glass 16. In order to prevent the window glass 16 and the carrier 15 from moving relatively to each other, portions of the carrier 15 to which the window glass 16 is installed are preferably two or more. In the present embodiment, portions of the carrier 15 to which the window glass 16 is to be installed are two.

As shown in FIG. 5, a surface of the carrier 15 which faces the guide rail 14 is a faced surface T. As shown in FIGS. 6(a) and 6(b), the faced surface T is provided with three protrusions 35, 36 and 37 as second engaging portions. The first and second protrusions 35 and 36 have a rectangular sectional shape (See FIG. 5) respectively, and are located to keep them separated as far as possible in the longitudinal direction of the guide rail 14. A third protrusion 37 has an inverted L-character-shaped sectional shape (See FIG. 5), and is located between the first protrusion 35 and second protrusion 36 in the longitudinal direction of the guide rail 14.

As shown in FIG. 5, the first and second protrusions 35 and 36 of the carrier 15 have been inserted between the first guide portion 31 and the second guide portion 32 of the guide rail 14. In this state, the first and second protrusions 35 and 36 of the carrier 15 abut against the first and second guide surfaces 31a and 32a and the guide underside 30a, and between the faced surface T of the carrier 15 and the guide rail 14, there exists a predetermined clearance. Also, the first guide portion 31 of the guide rail 14 is interposed between the first and second protrusions 35 and 36 and the third protrusion 37, and an upper end of the first guide portion 31 is engaged with a tip of the third protrusion 37. The first and second protrusions 35 and 36 abut against the first and second guide surfaces 31a, 32a, whereby movement of the carrier 15 relative to the guide rail 14 in a widthwise direction of the guide rail 14 is restrained. In other words, movement of the carrier 15 relative to the guide rail 14 in a direction orthogonal to the longitudinal direction of the guide rail 14 and parallel to a plane orthogonal to the thickness direction of the window glass 16 is restrained. The upper end of the first guide portion 31 engages with a tip of the third protrusion 37, whereby coming off of the carrier 15 from the guide rail 14 is restrained. In other words, movement of the carrier 15 relative to the guide rail 14 in the thickness direction of the window glass 16 is restrained.

As shown in FIGS. 6(a) and 6(b), the faced surface T of the carrier 15 is further provided with a receiving rail 40 as a first engaging portion. The receiving rail 40 receives the engaging projection 25 of the power transmission arm 21 and guides the engaging projection 25. As shown in FIGS. 6(b) and 8, the receiving rail 40 has first and second straight-line portions 41 and 42 which have been arranged in parallel to each other at a predetermined interval, and a coupling portion 43 for coupling end portions of those straight-line portions 41 and 42 to thereby form an U-character shape. The first and second straight-line portions 41 and 42 extend along a back-and-forth direction (in FIG. 6(b), left-and-right direction) of the vehicle indicated by an arrow V2 in FIG. 1 and 2(a).

As shown in FIGS. 6(a) and 6(b), the first and second straight-line portions 41 and 42 and the coupling portion 43 are provided with convex ridges 44. A portion of the first straight-line portion 41 which is provided with a portion of the convex ridge 44 is a portion of the first straight-line portion 41 farthest from the faced surface T, and a portion of the second straight-line portion 42 which is provided with another portion of the convex ridge 44 is a portion of the second straight-line portion 42 farthest from the faced surface T. Also, a portion of the coupling portion 43 which is provided with further another portion of the convex ridge 44 is a portion of the coupling portion 43 farthest from the faced surface T. The portion of the convex ridge 44 provided at the first straight-line portion 41 projects from a surface of the first straight-line portion 41 facing the second straight-line portion 42. The portion of the convex ridge 44 provided at the second straight-line portion 42 projects from a surface of the second straight-line portion 42 facing the first straight-line portion 41. As shown in FIG. 8, an interval between the portion of the convex ridge 44 provided at the first straight-line portion 41 and the portion of the convex ridge 44 provided at the second straight-line portion 42 is smaller than an interval between the first straight-line portion 41 and the second straight-line portion 42. The interval between the portion of the convex ridge 44 provided at the first straight-line portion 41 and the portion of the convex ridge 44 provided at the second straight-line portion 42 is also smaller than an outer size of the tip portion 25b of the engaging projection 25, and is larger than an outer size of the proximal end portion 25a of the engaging projection 25.

As shown in FIG. 3, the carrier 15 is located more in the outside of the vehicle (in FIG. 3, above) than the power transmission arm 21. As shown in FIG. 8, the tip portion 25b of the engaging projection 25 has been inserted between the first and second straight-line portions 41 and 42. An outer peripheral surface 25c of the tip portion 25b is spherical. In other words, the engaging projection 25 has a curve. The outer peripheral surface 25c abuts against the first and second straight-line portions 41 and 42. Since the outer peripheral surface 25c of the tip portion 25b is spherical, the carrier 15 is obliquely movable with respect to the power transmission arm 21. Since the outer peripheral surface 25c of the tip portion 25b abuts against the first and second straight-line portions 41 and 42, there is restrained movement of the tip portion 25b in a widthwise direction of the receiving rail 40 (widthwise direction of the first and second straight-line portions 41 and 42). In addition, the tip portion 25b of the engaging projection 25 is movable between the first and second straight-line portions 41 and 42 along the longitudinal direction thereof, and is also movable between the first and second straight-line portions 41 and 42 along the direction of height of the first and second straight-line portions 41 and 42.

As shown in FIG. 8, a height Hi of the first and second straight-line portions 41 and 42 is larger than the total of an axial size H2 of the tip portion 25b of the engaging projection 25 and a distance over which the carrier 15 moves in the direction of height of the guide rail 14. The distance over which the carrier 15 moves in the direction of height of the guide rail 14 is a distance, over which, when the carrier 15 moves on the guide rail 14 along the longitudinal direction of the guide rail 14, the carrier 15 moves in the direction of height of the guide rail 14. A cause why when the carrier 15 moves on the guide rail 14 along the longitudinal direction of the guide rail 14, the carrier 15 moves in the direction of height of the guide rail 14 is because as described above, the surface of the guide rail 14 facing away from the passenger compartment is a crook surface.

The receiving rail 40 is located more ahead (in FIG. 2(A), to the right) of the vehicle than the first to third protrusions 35 to 37. As shown in FIG. 6(b), the receiving rail 40 overlaps a domain S, which is a portion of the carrier 15 provided with the first to third protrusions 35 to 37, in the longitudinal direction of the guide rail 14. In other words, the longitudinal axis of the receiving rail 40 (longitudinal axes of the first and second straight-line portions 41 and 42) traverses the domain S.

Next, the description will be made of an operation of the door module 11.

In the door module 11 shown in FIG. 2(a), when the motor portion 20a of the window motor 20 is driven, the pinion gear 20d rotates via the gear portion 20b. Due to the rotation of the pinion gear 20d, the power transmission arm 21 rotates clockwise or counterclockwise with the arm supporting portion 22 as a fulcrum. When the power transmission arm 21 rotates clockwise in FIG. 2(a), the carrier 15 moves upward together with the window glass 16, while when the power transmission arm 21 rotates counterclockwise in FIG. 2(a), the carrier 15 moves downward together with the window glass 16.

A moving locus of the carrier 15 when the carrier 15 moves along the longitudinal direction of the guide rail 14 is curved with respect to the longitudinal direction of the guide rail 14. On the other hand, a moving locus of the engaging projection 25 on the power transmission arm 21 due to the rotation of the power transmission arm 21 is not curved with respect to the longitudinal direction of the guide rail 14, but is parallel to the panel outer surface 12b of the module panel 12. For the reason, the interval between the carrier 15 and the power transmission arm 21 in the thickness direction of the window glass 16 is large when the carrier 15 is located at a center of the guide rail 14 in the longitudinal direction, and is small when the carrier 15 is located at both ends in the longitudinal direction of the guide rail 14. However, since, as shown in FIGS. 7 and 8, the height H1 of the first and second straight-line portions 41 and 42 is larger than the total of the axial size H2 of the tip portion 25b of the engaging projection 25 and the distance over which the carrier 15 moves in the direction of height of the guide rail 14, the size of the interval between the carrier 15 and the power transmission arm 21 is permitted to vary. Therefore, the carrier 15 and the power transmission arm 21 smoothly work together irrespective of the size of the interval between the carrier 15 and the power transmission arm 21. In this respect, in FIGS. 1 and 2(a), the carrier 15 (15A, 15B) and the tip of the power transmission arm 21 (21A, 21B) when the carrier 15 is located at both ends of the guide rail 14 in the longitudinal direction are indicated by a two-dot chain line.

In addition, since the moving locus of the carrier 15 is curved with respect to the longitudinal direction of the guide rail 14, when the carrier 15 moves along the longitudinal direction of the guide rail 14, an angle that the carrier 15 forms with the power transmission arm 21 varies in accordance with the position of the carrier 15 in the longitudinal direction of the guide rail 14. As shown in FIG. 8, however, the carrier 15 obliquely moves with the center O of the tip portion 25b as the center with respect to the power transmission arm 21, whereby the angle that the carrier 15 forms with the power transmission arm 21 is permitted to vary. Therefore, the carrier 15 and the power transmission arm 21 smoothly work together irrespective of the angle that the carrier 15 forms with the power transmission arm 21.

As shown in FIG. 8, the interval between the portion of the convex ridge 44 provided at the first straight-line portion 41 and the portion of the convex ridge 44 provided at the second straight-line portion 42 is smaller than the outer size of the tip portion 25b of the engaging projection 25, and is larger than the outer size of the proximal end portion 25a of the engaging projection 25. For the reason, there is no possibility that the tip portion 25b of the engaging projection 25 comes off from between the first and second straight-line portions 41 and 42.

An amount of movement of the carrier 15 when the power transmission arm 21 rotates at a predetermined angle of rotation is different between when the carrier 15 is located in the vicinity of the center of the guide rail 14 in the longitudinal direction, and when the carrier 15 is located at both ends of the guide rail 14 in the longitudinal direction, and is larger when the carrier 15 is located in the vicinity of the center of the guide rail 14 in the longitudinal direction.

The present embodiment has the following advantages.

In the door module 11 according to the present embodiment, the window glass 16 is raised and lowered by the window motor 20, the power transmission arm 21, the carrier 15, and the guide rail 14, and there are fewer components relating to rise and fall of the window glass 16 than the conventional door module (window regulator device). In other words, the door module 11 according to the present embodiment is capable of raising and lowering the window glass with fewer components. Therefore, the door module 11 is low in manufacturing cost and easy to assemble.

As shown in FIG. 6(b), the receiving rail 40 overlaps the domain S, which is a portion of the carrier 15 provided with the first to third protrusions 35 to 37, in the longitudinal direction of the guide rail 14. In other words, a longitudinal axis of the receiving rail 40 (longitudinal axes of the first and second straight-line portions 41 and 42) traverses the domain S. If the receiving rail 40 does not overlaps the domain S in the longitudinal direction of the guide rail 14, a size of the carrier 15 in the longitudinal direction of the guide rail 14 will be equal to a sum of a size of the domain S in the longitudinal direction of the guide rail 14 and a size of the receiving rail 40 in the longitudinal direction of the guide rail 14. In the present embodiment, however, the size of the carrier 15 in the longitudinal direction of the guide rail 14 will suffice so long as there is at least the size of the domain S in the longitudinal direction of the guide rail 14. Therefore, it contributes to miniaturization, reduction in weight and reduction in material cost of the carrier 15 for the receiving rail 40 to overlap the domain S in the longitudinal direction of the guide rail 14.

The guide rail 14 has been integrally formed with the module panel 12. If the guide rail 14 is separately formed from the module panel 12, it will be necessary to fix the guide rail 14 to the module panel 12 through the use of, for example, bolts. In contrast, in the present embodiment, there is no need for fixing the guide rail 14 to the module panel 12, but less number of components is required.

A height H1 of the first and second straight-line portions 41 and 42 is larger than the total of an axial size H2 of the tip portion 25b of the engaging projection 25 and a distance over which the carrier 15 moves in the direction of height of the guide rail 14. For the reason, the tip portion 25b of the engaging projection 25 is movable between the first and second straight-line portions 41 and 42 along the direction of height of the first and second straight-line portions 41 and 42. Therefore, even if the power transmission arm 21 and the carrier 15 has no flexibility, the carrier 15 and the power transmission arm 21 smoothly work together irrespective of the size of the interval between the carrier 15 and the power transmission arm 21 in the thickness direction of the window glass 16. Also, even if the power transmission arm 21 or the carrier 15 has flexibility, the deformation of the carrier 15 or the power transmission arm 21 is prevented. The deformation of the carrier 15 or the power transmission arm 21 causes loss in power transmission from the power transmission arm 21 to the carrier 15. In contrast, in the present embodiment, loss in power transmission due to the deformation of the carrier 15 or the power transmission arm 21 is prevented.

The carrier 15 is obliquely movable with respect to the power transmission arm 21. For the reason, even if the power transmission arm 21 and the carrier 15 has no flexibility, the carrier 15 and the power transmission arm 21 smoothly work together irrespective of the angle that the carrier 15 forms with power transmission arm 21. In other words, although a surface of the guide rail 14 facing away from the passenger compartment is a crook surface, the carrier 15 and the power transmission arm 21 smoothly work together

The first to third protrusions 35 to 37 engage with the first guide portion 31 of the guide rail 14, whereby the carrier 15 is restrained from moving relative to the guide rail 14 in any other directions than the longitudinal direction of the guide rail 14. For the reason, the window glass 16 to be installed to this carrier 15 is also restrained from moving relative to the guide rail 14 in any other directions than the longitudinal direction of the guide rail 14. Therefore, a window frame for preventing the window glass 16 from moving in any other directions than the longitudinal direction of the guide rail 14 may be either located above the door D or not. In other words, the door module 11 according to the present embodiment can be mounted on either of vehicles of a type of having window frames and of a type of having no window frame.

In the door module 11 according to the present embodiment, the first and second protrusions 35 and 36 abut against the first and second guide surfaces 31a and 32a, whereby the carrier 15 is restrained from moving in a widthwise direction of the guide rail 14. And the upper end of the first guide portion 31 engages with the tip of the third protrusion 37, whereby the carrier 15 is restrained from coming off from the guide rail 14. Therefore, the carrier 15 is capable of moving on the guide rail 14 with stability along the longitudinal direction of the guide rail 14. Also, in a state in which the first and second protrusions 35 and 36 of the carrier 15 have been inserted in the guide groove in the guide rail 14, between the faced surface T of the carrier 15 and the guide rail 14, there exists a predetermined clearance. For the reason, even if there may be more or less asperities on the first and second guide portions 31 and 32 of the guide rail 14, the carrier 15 is capable of moving with stability on the guide rail 14 along the longitudinal direction of the guide rail 14.

In the window regulator device disclosed in the Japanese Laid-Open Patent Publication No. 6-146708, a pair of guide rails guide the window glass when the window glass rises and falls. For the reason, when installing the guide rails, particularly high precision is required concerning relative positions between both guide rails. In contrast, in the door module 11 according to the present embodiment, guide rail 14 guides the window glass 16 when the window glass 16 rises and falls. For the reason, as compared with when installing the guide rails in the window regulator device according to the Japanese Laid-Open Patent Publication No. 6-146708, the so-high precision is not required when installing the guide rail 14. In other words, it is comparatively simple to install the guide rail 14.

The guide rail 14 does not curve, but extends in a straight line along the up-and-down direction substantially. The guide rail 14 extending in the straight line is easier to be manufactured and installed than a curved guide rail, and contributes to reduction in manufacturing cost of the door module 11. Also, the first and second straight-line portions 41 and 42 of the receiving rail 40 do not curve, but extend in the straight line. The receiving rail 40 having the first and second straight-line portions 41 and 42 which extend in the straight line is easier to be manufactured and installed than the receiving rail having the curved portions, and contributes to reduction in the manufacturing cost of the door module 11.

Transmission of power from the power transmission arm 21 to the carrier 15 is not mediated by any other members than the power transmission arm 21 and the carrier 15, but is directly performed. Therefore, according to the present embodiment, loss during power transmission from the power transmission arm 21 to the carrier 15 is reduced as compared with when the transmission of power from the power transmission arm 21 to the carrier 15 is mediated by any other members than the power transmission arm 21 and the carrier 15.

According to the present embodiment, the amount of movement of the carrier 15 when the power transmission arm 21 rotates at a predetermined angle of rotation is different between when the carrier 15 is located in the vicinity of the center of the guide rail 14 in the longitudinal direction, and when the carrier 15 is located at both ends of the guide rail 14 in the longitudinal direction, and is larger when the carrier 15 is located in the vicinity of the center of the guide rail 14 in the longitudinal direction. In other words, when the carrier 15 is located at both ends of the guide rail 14 in the longitudinal direction, rise and fall speed of the window glass 16 becomes slower. Accordingly, before the window glass 16 is fully opened or fully closed, an operability when the window glass 16 is raised or lowered only a little is improved.

The first and second protrusions 35 and 36 are located to keep them separated as far as possible in the longitudinal direction of the guide rail 14. The larger the interval between the first and second protrusions 35 and 36 in the longitudinal direction of the guide rail 14 is, the lower load to be applied to each of the first and second protrusions 35 and 36 when a force for moving the carrier 15 in a widthwise direction of the guide rail 14 is applied to the carrier 15 is. Therefore, it contributes to miniaturization and reduction in weight of the first and second protrusions 35 and 36 that the first and second protrusions 35 and 36 are located to keep them separated as far as possible in the longitudinal direction of the guide rail 14.

The module panel 12 is light-weight because it is made of synthetic resin. Also, it reduces man-hour concerning manufacture of the module panel 12 and the guide rail 14 and reduces the manufacturing cost of the door module 11 that the module panel 12 and the guide rail 14 have been integrally formed.

It should be apparent to those skilled in the art that the present invention may be embodied in many other specific forms without departing from the spirit of scope of the invention. Particularly, it should be understood that the invention may be embodied in the following forms.

The module panel 12 and the guide rail 14 may be formed of metal in place of synthetic resin.

The receiving rail 40 may not necessarily overlaps the domain S, which is a portion of the carrier 15 provided with the first to third protrusions 35 to 37, in the longitudinal direction of the guide rail 14. In other words, a longitudinal axis of the receiving rail 40 (longitudinal axes of the first and second straight-line portions 41, 42) may not necessarily traverse the domain S.

The outer peripheral surface 25c of the tip portion 25b of the engaging projection 25 may be not spherical. In this case, however, it is necessary that the outer size of the tip portion 25b is smaller than the interval between the first straight-line portion 41 and the second straight-line portion 42, and is larger than the interval between the portion of the convex ridge 44 provided in the first straight-line portion 41 and the portion of the convex ridge 44 provided in the second straight-line portion 42.

The carrier 15 may be not obliquely movable with respect to the power transmission arm 21 instead of being obliquely movable with respect to the power transmission arm 21. In this case, however, it is necessary that the power transmission arm 21 or the carrier 15 has flexibility.

The tip portion 25b of the engaging projection 25 may be not movable between the first and second straight-line portions 41 and 42 along the direction of height of the first and second straight-line portions 41 and 42. In this case, however, it is necessary that the power transmission arm 21 or the carrier 15 has flexibility.

The guide rail 14 may be separately formed from the module panel 12 instead of being integrally formed with the module panel 12. In this case, the guide rail 14 is fixed to the module panel 12 through the use of, for example, bolts.

In place of the first and second protrusions 35 and 36, long lengths of protrusion for cutting vertically the carrier 15 along the longitudinal direction of the guide rail 14 may be provided on the faced surface T of the carrier 15.

In place of the receiving rail 40, the engaging projection 25 may be provided on the carrier 15, and in place of the engaging projection 25, the receiving rail 40 may be provided on the power transmission arm 21.

The door module 11 may be installed to a rear door or back gate of an automobile.

The present examples and embodiments are to be considered as illustrative and not restrictive and the invention is not to be limited to the details given herein, but may be modified within the scope and equivalence of the appended claims.

1. A door module for moving a window glass, the door module comprising:
a window motor;
a power transmission arm, which is operably coupled to the window motor, wherein the power transmission arm is rotated about a predetermined rotation axis by the window motor, and wherein the power transmission arm has a power transmission portion located apart from the rotation axis;
a guide member, which extends along a moving direction of the window glass, wherein the moving direction of the window glass is a direction along which the window glass moves; and
a carrier, which is supported by the guide member so as to be movable along the moving direction of the window glass, wherein the window glass is installed onto the carrier, wherein the carrier, together with the window glass, is moved on the guide member along the moving direction of the window glass, and wherein the carrier has a first engaging portion engaged with the power transmission portion so that the carrier is moved along the moving direction of the window glass in accordance with the rotation of the power transmission arm, and has a second engaging portion engaged with the guide member so as to restrain the carrier from moving relative to the guide member along a direction that intersects the moving direction of the window glass.

2. The door module according to claim 1, wherein the second engaging portion restrains the carrier from moving relative to the guide member along a direction orthogonal to the moving direction of the window glass and parallel to a plane orthogonal to the thickness direction of the window glass.

3. The door module according to claim 1, wherein the second engaging portion restrains the carrier from moving relative to the guide member along the thickness direction of the window glass.

4. The door module according to claim 1, wherein the guide member has a pair of guide surfaces facing each other, wherein the surfaces are arranged along a direction orthogonal to the moving direction of the window glass, wherein the second engaging portion is one of a plurality of second engaging portions, wherein each of the second engaging portions is placed at a predetermined interval between itself and other one of the second engaging portions along the moving direction of the window glass, and wherein, when the carrier is moved along the moving direction of the window glass, each of the second engaging portion is slid on both guide surfaces.

5. The door module according to claim 1, wherein the first engaging portion overlaps a portion of the carrier provided with the second engaging portion in the moving direction of the window glass.

6. The door module according to claim 1, further comprising a module panel for rotatably supporting the power transmission arm, wherein the guide member is integrally formed with the module panel.

7. The door module according to claim 1, wherein the first engaging portion is engaged with the power transmission arm so that the size of an interval between the carrier and the power transmission arm in the thickness direction of the window glass is permitted to vary.

8. The door module according to claim 7, wherein the guide member has a crook surface, and wherein the carrier is moved on the crook surface of the guide member along the moving direction of the window glass, thereby the size of said interval between the carrier and the power transmission arm is varied.

9. The door module according to claim 1, wherein the first engaging portion is engaged with the power transmission arm so that an angle that the carrier forms with the power transmission arm is permitted to vary.

10. The door module according to claim 9, wherein the guide member has a crook surface, and wherein the carrier is moved on the crook surface of the guide member along the moving direction of the window glass, thereby the angle that the carrier forms with the power transmission arm is varied.

11. The door module according to claim 9, wherein one of the power transmission arm and the first engaging portion has a curve abutting against other one of the power transmission arm and the first engaging portion, and wherein the curve allows the angle that the carrier forms with the power transmission arm to vary.

12. The door module according to claim 1, wherein the power transmission arm is an engaging projection and the first engaging portion is a receiving rail having a longitudinal axis, wherein the receiving rail receives the engaging projection and guides the engaging projection along the longitudinal axis of the receiving rail, and wherein the longitudinal axis of the receiving rail traverses a portion of the carrier provided with the second engaging portion.

13. The door module according to claim 1, wherein the module panel is made of synthetic resin.

14. The door module according to claim 6, wherein the module panel and the guide member are made of synthetic resin.
